(19) United States
(12) Patent Application Publication
(10) Pub. No.: US 2003/0039949 A1
(43) Pub. Date: Feb. 27, 2003

(54) Method and system for correlating a plurality of information resources

(76) Inventors: David Cappellucci, Wayland, MA (US); Kirby Mansfield, Pepperell, MA (US); Sandeep Gupta, Somerville, MA (US)

Correspondence Address: MINTZ, LEVIN, COHN, FERRIS, GLOVSKY and POPEO, P.C., One Financial Center, Boston, MA, 02111, US

(21) Appl. No.: 10/125,890

(22) Filed: Apr. 19, 2002

Related U.S. Application Data
(60) Provisional application No. 60/285,271, filed on Apr. 23, 2001.
(60) Provisional application No. 60/370,821, filed on Apr. 8, 2002.
(60) Provisional application No. 60/370,822, filed on Apr. 8, 2002.

(51) Int. Cl. G09B 7/00

(52) U.S. Cl. 434/362

(57) ABSTRACT

The present invention is directed to a scalable method and system for efficiently correlating large volumes of information resources. In an e-learning system many large and disparate of educational information resources can be combined and accessed quickly and efficiently. The system made very scalable by the use of central database of learning objectives referred to as a set of Master Learning Objectives or MLOs. Each information object and element of each information resource can be correlated to one or more MLOs in order to establish a link or relationship between the information object or element and the MLO. Once an information object or element is linked to an MLO, additional information objects and elements corresponding to the same subject as the first information object or element can be located by searching for all other information objects and elements linked to the same MLO. In addition, the MLOs can be hierarchically arranged in tree structure in order to further facilitate identifying information objects and elements that correspond to a given MLO or subset of MLOs.

### CROSS-REFERENCE TO RELATED APPLICATIONS

This application claims the benefit of priority to U.S. S. No. 60/285,271 filed Apr. 23, 2001, entitled Methods and Systems for Providing Online Standards of Learning Data, U.S. S. No. (______—Attorney Docket No. 02905.504) filed on Apr. 8, 2002, entitled Dynamic Content Delivery System and U.S. S. No. (______—Attorney Docket No. 02905.503) filed on Apr. 8, 2002, entitled Method and System for Correlating a Plurality of Information Resources, all of which are incorporated herein by reference in their respective entirety.

This application is related to U.S. Ser. No. [______—Attorney Docket No. 02905.506] filed on Apr. 19, 2002, entitled Dynamic Content Delivery System and is hereby incorporated by reference.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to methods and systems for online standards based learning and, more particularly, to a method and system for correlating many large and diverse information resources and providing efficient organization and delivery of the information to users.

Generally, computer systems are arranged and configured to enable users to obtain access to information and information resources. Depending upon the needs of the user, the information can be located by searching or using search tools. Typically, a user searches for information by presenting search criteria to the computer system which uses well known algorithms and processes to isolate the information that meets the search criteria. In some systems, the information is classified or associated with one or more criteria, for example information relating to mathematics, physics or chemistry and the user can limit their search to information within a specific classification in order to limit the search results to a more manageable size. In addition, the classification structure can be hierarchical, providing for many degrees of organization by providing many levels sub-classification. However, these systems do not provide correlations or links between information resources, objects or elements of information resources. Thus, there is no way for one to know whether a particular information resource, object within the information resource or element within an information object is related in some way to another information resource, object or element.

One method of enabling users to find related information resources, objects or element is to provide a correlation system such as a table which links each information resource, object or element to each other related information resource, object or element based upon predefined criterion. Thus, for example using educational information, mathematic information can be linked to other mathematic information and 5^{th} grade information can be linked to other 5^{th} grade information.

A simple direct linking system can be acceptable where a few information resources can be directly linked or related to each other. However, where many information resources need to linked or related, the mechanism for maintaining the correlation (the links and/or relations) between each information resource becomes increasingly large and complex. For example, a system with N resources would require N*(N−1)/2 correlations in order to link each resource to the N−1 remaining resources and each resource correlation can include at least one entry for each information resource object or element correlated. In addition to having to maintain N−1 resource correlations, the number of resource correlations increases by N with the addition of each new resource.

Each time a new information resource is added, each information object or element in that new resource must be linked to the information objects or elements of existing resources in N−1 new tables. Existing resources change as new information objects or elements are added and others deleted. When these information objects are added to or deleted from existing resources, the N−1 correlation tables must be changed to reflect the additions or deletions. Such a system is inefficient to manage and lacks the ability to scale.

In addition, as the number of users and volume of information resources grow, the computer system used to provide access to the information must also grow or scale to meet the increasing user demand. Depending upon the user access profile, the system may need to scale in different ways to meet different types of load requirements.

One example of an environment which can involve large quantities of information resources is the educational resource environment. There are many diverse resources of educational information. For purposes of illustration, a sample list of the types of some educational resources that can be used in an online learning system: lesson plan resources, standards resources (State, district and school standards), assessment resources, professional development resources, student resources and textbook derived resources. In addition, in a typical system, it would not be uncommon to include many disparate information resources from each type.

It is desirable for a user (an administrator, an educator, a parent or a student) to have full and immediate access to all appropriate educational resources. For example, every year hundreds or thousands of teachers may teach a weeklong chapter on exponents in a Trigonometry course and each of those teachers might want to do some or all of the following:

Develop a lesson plan that fits the topic of exponents into a week-long schedule;

Pick and choose which activities should be part of the lesson plan;

Possibly substitute activities and materials from outside sources;

Obtain teacher-oriented (professional development) materials that would show the best way to teach difficult concepts (these could be text, video, or audio);

Orient the lesson plan to cover certain state and district standards;

Develop a set of assessment tests to evaluate the student's knowledge of the topic both before and after the lesson

Where the resources above are not correlated, the educator is left to her own devices to determine whether the units or activities she selected are going to align with the state and district standards. Similarly, she may not know whether her assessment tests, the materials from outside sources or any teacher oriented (professional development) materials are going to align with the units and activities and the state and district standards.

Accordingly, it is an object of this invention to provide an improved method and system for correlating many information resources.

### SUMMARY OF THE INVENTION

The present invention is directed to a method and system for correlating information within a system that derives information from a plurality of disparate informational resources. In accordance with the invention, the method and system are scalable and provide for the efficient use of resources in the event that information objects are added to, modified or deleted from the system. While the method and system of the invention can be used to retrieve, optionally assemble and deliver information to users of the information, the invention can also be used in methods and systems for storing information.

The system includes a plurality of separate information resources, each information resource including a plurality of information objects (which can include one or more information elements), a central or reference information resource including a plurality of reference information objects, and a correlation system for correlating, validating, re-correlating and previewing the information objects and elements of the information resource with the reference information objects of the reference information resource. The system can also include a searching system which is adapted for locating and retrieving information objects and elements that are correlated to one or more reference information objects or for locating and retrieving further information objects and elements that are correlated to the same reference information object. The system information objects and elements can be customized by the user and both system and customized information objects and elements can be combined with other information objects and elements provided by the user to produce customized information objects and elements that can be made available to users of the system. The system can also be part of or include a delivery system for delivering information objects located and retrieved by the searching system. The system can further include a presentation system, which may or may not be part of the delivery system, which is adapted for presenting the information objects and elements according to an undefined or a predefined style, format or template. The information delivery system can be part of a system that can provide electronic commerce services, business-to-business (b2b) data exchange services such as a business or educational content gateway, or other value added services such as information manipulating and processing services and related activities.

The system can include a plurality of separate educational information resources, each educational information resource can include a plurality of educational information objects (which can include a one or more educational information elements), an educational reference information resource including a plurality of reference information objects, such as for example, a set of master learning objectives, and a correlation system for correlating, validating, re-correlating and previewing the educational information objects and elements of the educational information resource with the reference information objects or learning objective of the reference information resource. The system can also include a searching system which is adapted for locating and retrieving educational information objects and elements that are correlated to one or more learning objectives or for locating and retrieving further information objects and elements that are correlated to the same learning objective. The information objects and elements can be customized by the user and both system and customized information objects and elements can be combined with information objects and elements provided by the user to produce customized information objects and elements that can be made available to users of the system. The system can also be part of or include a delivery system for delivering educational information objects and elements located and retrieved by the searching system. The system can further include a presentation system, which may or may not be part of the delivery system, which is adapted for presenting the educational information objects and elements according to an undefined or predefined style, format or template.

The educational information objects can, for example, include national standards resources, state standards resources, district standards resources, professional development resources, assessment resources, lesson plan and other curriculum resources, student resources, and textbook resources. The master learning objectives can include a plurality of hierarchically organized levels of learning objectives. The hierarchy can be organized whereby higher levels include more general categories of learning objectives and lower levels include more specific categories of learning objectives. The delivery system can be adapted for delivering one or more information objects or elements to a user as a function of a correlation defined between a learning objective and an educational information object or element.

The system can allow users to develop and store information objects and elements developed by the use in the user's own private storage area. These information objects and elements can be used to produce customized information objects and elements which can be stored in one or more of the information resources available through the system. A user can develop a customized information object by combining system information objects and elements and information objects stored in the user's own private storage area. The system can combine various system and user developed objects and elements to produce a customized information object or element that is stored in one or more of the information resources and made available to other users or it can be stored in the user's private storage area. The system can also provide several output options, such as making the information object or element available at a user terminal or can be printed on any output device. In addition, both system and customized information objects and elements can also be delivered to a third party service provider, such as a printing service or material supply service, to provide further services, such as printing and binding, ordering supplies and materials for a hands on activity or creating model or prototype.

The method includes providing a plurality separate information resources, each information resource including a plurality of information objects (which can include one or more information elements), providing a reference information resource including a plurality of reference information objects, and correlating the information objects or elements of an information resource with one or more reference information objects of the reference information resource. The method can also include the steps of locating and retrieving information objects or elements that are correlated to one or more reference information objects or elements or the steps of locating and retrieving further information objects and elements that are correlated to the same reference information object or element. The method can also include the step of delivering information objects and elements located and retrieved in a locating and retrieving step. The method can further include presenting the information objects and elements according to an undefined or predefined style, format or template.

The method can include providing a plurality separate educational information resources, each educational information resource including a plurality of educational information objects (which can include one or more educational information elements), providing an educational reference information resource or set of master learning objectives including a plurality of educational reference information objects or master learning objectives, and correlating the educational information objects or elements of an educational information resource with one or more learning objectives of the set of master learning objectives. The method can also include the steps of locating and retrieving educational information objects and elements that are correlated to one or more learning objectives or the steps of locating and retrieving further educational information objects and elements that are correlated to the same learning objective as one or more primary educational information objects or elements. The method can also include the step of delivering educational information objects and elements located and retrieved in a locating and retrieving step. The method can further include presenting the educational information objects and elements according to an undefined or predefined style, format or template.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagram showing a free form information model of N=6 information resources;

FIG. 2 is a diagram showing an information model in accordance with the invention of N=6 information resources;

FIG. 3 is a diagrammatic view of a set of master learning objectives in accordance with the present invention;

FIG. 4 is a diagram of how information objects and elements of diverse information resources can be correlated to the master learning objectives in accordance with the invention;

FIG. 5 is a diagram of a system in accordance with the invention;

FIG. 6 is a flow chart of a method for providing correlations between information resources in accordance with the invention;

FIG. 7 is a flow chart of a method for finding state standards that correlate to input criteria in accordance with the invention;

FIGS. 8A and 8B flow chart of an alternate method for finding state standards that correlate to input criteria in accordance with the invention;

FIG. 9 is a flow chart of a further alternate method for finding state standards that correlate to input criteria in accordance with the invention;

FIGS. 10 and 11 are diagrammatic views of a set of data structures for correlating a plurality of information resources in accordance with the invention; and

FIGS. 12 and 13 are diagrammatic views of a set of data structures for storing user information in an embodiment of the present invention.

### DETAILED DESCRIPTION OF THE PREFERRED EMBODIMENTS

The present invention is directed to a method and system for correlating, relating or linking information within a system that derives information from a plurality of information resources that can be disparate, unrelated and separated. In accordance with the invention, the method and system are scalable and provide for the efficient use of resources in the event that information resources or information objects are added or deleted. While the method and system of the invention can be used in systems that are adapted for delivering information to users of the information, the invention can also be used in methods and systems for storing information. In order to facilitate a better understanding of the invention, the invention below is described below in one or more illustrative examples or embodiments.

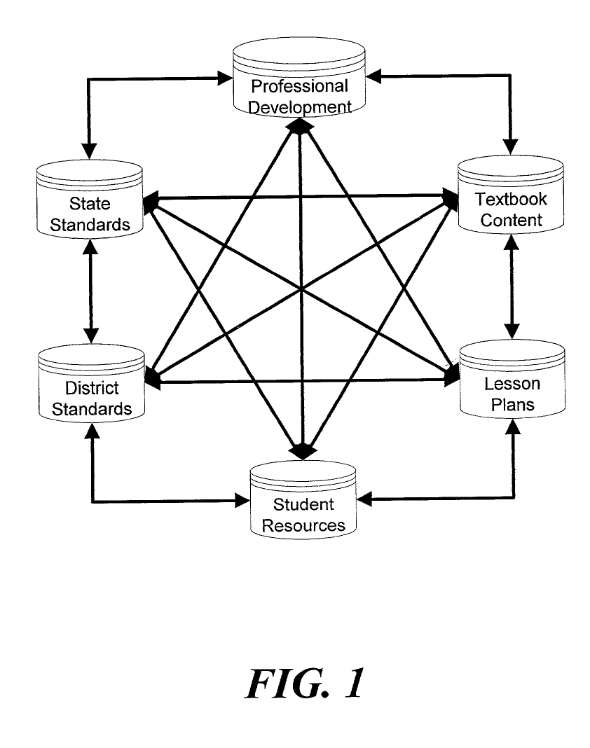

FIG. 1 shows a diagram representing a free form correlation between N=6 educational information resources as may be found in an electronic learning or “e-learning” system in accordance with the present invention. As shown, the free form correlation model, where N=6, requires N*(N−1)/2 or 15 correlations in order to relate each educational information resource to each other educational information resource. In practical terms, 15 separate tables or databases would be required in order to define the correlation (the relationship or links) between each of the six educational information resources. If a seventh educational information resource were to be added to the system, six additional correlations would have to be established by providing six additional tables or databases. For each information object or element that is added, deleted or otherwise changed, five correlations would have to be added, deleted or changed by modifying five tables or databases. Thus, the free form correlation model shown in FIG. 1 would require significant resources to manage and maintain.

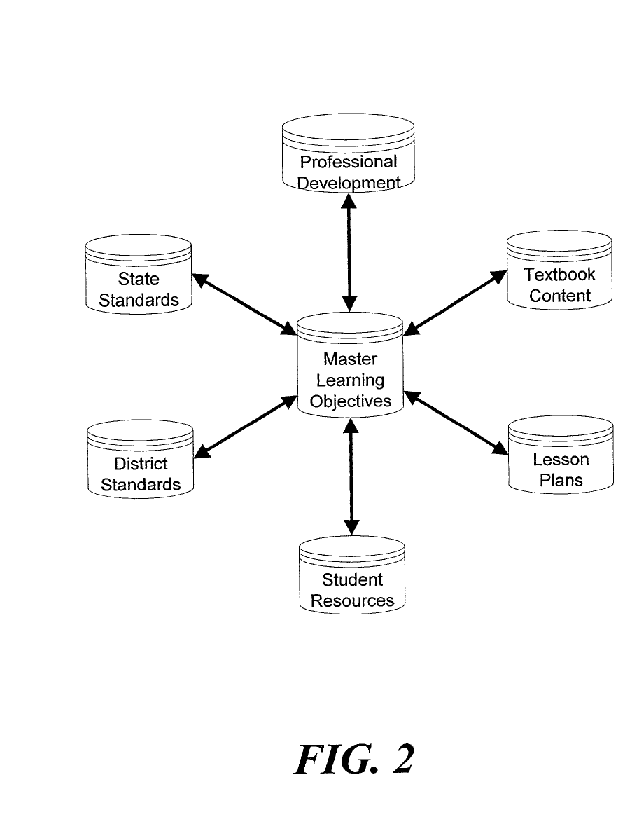

FIG. 2 shows a diagram of a system in accordance with the invention for establishing correlations between a plurality of informational resources that can be disparate, unrelated and separated. The illustrative system is an e-learning system for providing educational information to users, which can include administrators, teacher, students and parents. In accordance with the invention, and for purposes of illustration, categories or types of educational information resources and examples are further described below:

1. Lesson Plans—A lesson plan is a teacher's schedule for teaching a set of learning objectives. Lesson plans can range from short term (5 days) to long term (semester). Long-term lesson plans are also called scope sessions. Lesson plans can include day-to-day or week-to-week objectives, activities, questions, teaching strategies, or class-grouping suggestions. The elements that make up a lesson plan object can include activities, assignments, objectives, strategies, and questions.

2 Standards—National, State, district and school standards are listings of learning objectives broken by categories, such as grade-level and subject category. The state standards and objectives are typically high level. It is up to the individual districts and schools to make each learning objective into more detailed sets of learning objectives and curriculums. The element of a standards object can include subject descriptions, objectives and grade level.

3. Assessments—In order to test the student body's grasp of the state and/or district standards, assessments can be given by teachers, schools, districts or states. The time period for such assessments may cover years, semesters, or even weeks. The assessment may also cover a particular activity or unit of teaching or learning objective. Assessment functionality includes the ability to rate the performance of a student against statistical performance data and against any required standards. Preferably, deficient areas of study will become evident after an assessment. The elements that make up an assessment objects can include test questions and answer sets.

4. Professional Development—refers to the resources that aid a teacher in understanding or teaching a concept or a course. Sometimes such resources may show the teacher a clever way to teach a particular concept. Some resources can include entire mini-courses, designed to refresh the teacher on the concepts that they will be teaching. For example, a video (vignette) that shows how to prepare an in-class demonstration on magnetism using solenoids.

5. Student Resources—can include any material, regardless of form, that aids a student in understanding a concept. This material can include reading material, exercises, physical objects or experiments or an interactive computer program. Often these resources are taken home for the purposes of remedial learning.

6. Text Books—are the paperbound legacy data store with which most K-college students are familiar. Textbooks can be stored in an electronic form. A textbook or a portion of a textbook can be broken down into logical learning units or elements. Sometimes these elements will align with the sections, paragraphs, and/or chapters of a book and sometime they will not.

7. Other resources—these include other online systems such as the World Wide Web (WWW) and the Internet in general that can be a resource for educational information. This can also include user private information objects and elements. Preferably, these resources can be pre-qualified and an interface can be developed to allow the system to interact with and access the information available through these types of resources.

It should be noted that in a typical system, it would not be uncommon to provide many educational information resources from a single type of resource listed above and in general, many educational information resources from may, if not all, of the resource types. For example, there will typically be at least two educational standards resources, the state standard and one or more district (and local) standards associated with a given system as well as many different assessment, textbook and lesson plan resources in the given system. The system can be flexible to allow the use of new information resources that do not fall within the types listed above. New types of information resources can be defined within the system as need to allow the system to expand to accommodate new information resources.

FIG. 2 shows information resources as shown in FIG. 1 and, in accordance with the invention, the central or reference information resource which is embodied in a set of master learning objectives (“MLOs”). The MLOs help the system to be efficient and scalable because they enable the system to more easily modified. As a practical matter, state and district standards, assessment, textbooks and lesson plans can change over time, thus making the free form correlation based system time consuming and difficult to maintain. In accordance with the invention, the MLOs provide a system that is not subject to these disadvantages. However, should be noted that one disadvantage of the MLO based system is that is requires a level of indirection; that is, all resource objects and elements are not linked directed to each other, but indirectly via an MLO. This can provide some inefficiency and possibly some limitation on accuracy.

Preferably, the MLOs are static, comprehensive and sufficiently granular to meet the goals of the system. Because all of the other information resources referenced to the MLOs, it is desirable that MLOs do not change. That is not to say that MLOs should not ever change, as additional categories of educational resource objects and elements are added it may be desirable to revise the MLOs to accommodate this change, recognizing that, depending upon the nature of the change, frequent changes in the MLOs may require a significant expenditure of resources. Preferably, the MLOs should be comprehensive, whereby the scope of data covered within the MLO structure includes all the information objects and elements of each information resource. For example, the scope of the set of MLOs can include the scope of the union of all the data objects and elements of all the information resources. Preferably, the MLOs are arranged hierarchically with higher levels corresponding to more general categories of learning objectives and lower levels corresponding to more specific categories of learning objectives. Preferably, the MLOs should be sufficiently granular to accurately correlate information objects and elements from diverse information resources. In one embodiment, at the lowest level, the learning objectives can be the singular atomic unit of knowledge or learning and sufficiently specific and detailed to correlate to the most granular element of any educational information resource of the system. Thus, the MLOs are comprehensive in that there sufficient categories to provide a broad scope and accurate in that they are specifically detailed in order to correlate or correspond to the most detailed or specific information object or element from the information resources.

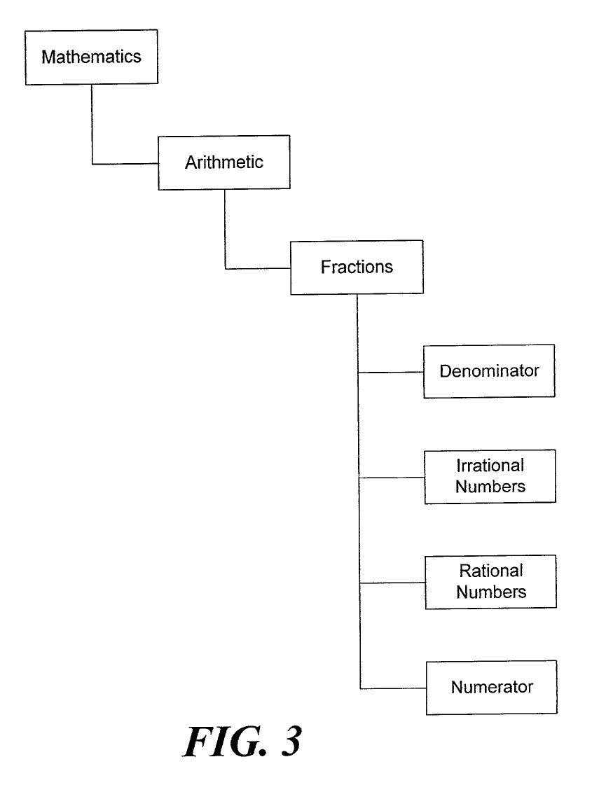

FIG. 3 shows a sample of a set of MLOs (which could be part of a larger set of MLOs) organized in a hierarchical tree structure 300. Each node on the tree can represent a category of learning objectives, with the higher level nodes corresponding to more general categories, such as Mathematics 310, Arithmetic 312 and fractions 320 and the lower level nodes corresponding to more detailed and specific categories, such as denominator 322, irrational numbers 324, rational numbers 326 and numerator 328. All the nodes in the tree can be considered learning objectives and the level of detail of the category can be commensurate with the subject matter and the level within the hierarchy.

Table 1 below provides a further sample of a set or subset of MLOs. As can be seen from this example, a learning objective can be a textual description of an atomic unit of knowledge. The general category, “Real Number Systems” (M6) is a learning objective even though it serves also as a categorization for more detailed and granular learning objectives, such as “Understands concept of addition” (M6.17.1). Each level down the tree corresponds to a set of more specific learning objectives.

| | | | |
|---|---|---|---|
| M6 | REAL NUMBER | | |
| | SYSTEMS | | |
| M6.2 | | Dramatizes number | |
| | | stories | |
| M6.3 | | Explores the | |
| | | concept of addition | |
| | | using concrete | |
| | | materials | |
| M6.4 | | Understands | |
| | | meaning: using | |
| | | concrete materials | |
| M6.5 | | Understands | |
| | | meaning: using | |
| | | pictorial materials | |
| M6.6 | | Compares and | |
| | | orders: whole | |
| | | numbers | |
| M6.7 | | Understands/uses | |
| | | ordinal numbers | |
| M6.8 | | Understands whole | |
| | | number place value | |
| M6.9 | | Whole number | |
| | | properties: addition | |
| M6.10 | | Whole number | |
| | | properties: | |
| | | subtraction | |
| M6.11 | | Whole number | |
| | | properties: | |
| | | multiplication | |
| M6.12 | | Whole number | |
| | | properties: division | |
| M6.13 | | Understands/uses | |
| | | Roman numerals | |
| M6.14 | | Understands/uses | |
| | | exponents | |
| M6.15 | | Understands/uses | |
| | | scientific notation | |
| M6.16 | | Understands/uses | |
| | | square numbers and | |
| | | square units | |
| M6.16.1 | | Compares and | |
| | | orders: decimals | |
| M6.16.2 | | Compares and | |
| | | orders: integers | |
| M6.16.3 | | Compares and | |
| | | orders: rational | |
| | | numbers | |
| M6.16.4 | | Understands/uses | |
| | | decimal place value | |
| M6.16.5 | | Uses 2-3 digit | |
| | | numbers | |
| M6.16.6 | | Uses 3-4 digit | |
| | | numbers | |
| M6.16.7 | | Uses larger numbers | |
| M6.16.8 | | Understands the | |
| | | concept of | |
| | | subtraction | |
| M6.16.9 | | Uses problem | |
| | | solving strategies | |
| M6.17 | | ADDITION | |
| M6.17.1 | | | Understands concept |
| | | | of addition |
| M6.17.2 | | | Uses problem |
| | | | solving strategies |
| M6.17.3 | | | Understands |
| | | | meaning: using |
| | | | symbols |
| M6.17.4 | | | Estimates sums |
| M6.17.5 | | | Explores com- |
| | | | mutative property |
| | | | of + |
| M6.17.6 | | | Understands com- |
| | | | mutative property |
| | | | of + |
| M6.17.7 | | | Basic Fact |
| | | | Strategies: |
| | | | counting on |
| M6.17.8 | | | Basic Fact |
| | | | Strategies: |
| | | | counting on from |
| | | | larger number |
| M6.17.9 | | | Basic Fact |
| | | | Strategies: |
| | | | adding zero |
| M6.16.10 | | | Basic Fact |
| | | | Strategies: doubles |
| M6.16.11 | | | Basic Fact |
| | | | Strategies: doubles |
| | | | plus one |
| M6.16.12 | | | Basic Fact |
| | | | Strategies: makes a |
| | | | ten |
| M6.17.13 | | | Uses vertical and |
| | | | horizontal formats |
| M6.17.14 | | | Recognizes fact |
| | | | families |
| M6.16.15 | | | Adds mentally, |
| | | | using addition |
| | | | strategies |
| M6.16.16 | | | Finds the sum of |
| | | | more than 2 addends |
| M6.16.17 | | | Recognizes the |
| | | | inverse relationship |
| | | | of addition and |
| | | | subtraction |
| M6.16.18 | | | Adds 2 digit |
| | | | numbers with and |
| | | | without regrouping |
| M6.16.19 | | | Adds 3 digit |
| | | | numbers with and |
| | | | without regrouping |
| M6.16.20 | | | Adds more than 4 |
| | | | digit numbers with |
| | | | and without |
| | | | regrouping |
| M6.16.21 | | | Connects concrete |
| | | | to abstract |
| M6.16.22 | | | Understands missing |
| | | | addends |

In addition, the MLOs, the information objects and elements and their correlations can be multidimensional. The MLOs, the information objects and elements and their correlations can include meta data that can provide an indication of other attributes of the information object or resource, such as learning styles, teaching modalities and other descriptive information. The meta data information can provide one or more additional dimensions and can make the correlations more accurate. For example, a correlation to a lesson plan can be more accurate and useful if it includes meta data indicating that the lesson plan is directed toward a particular grade level, advanced students or student where English is their second language.

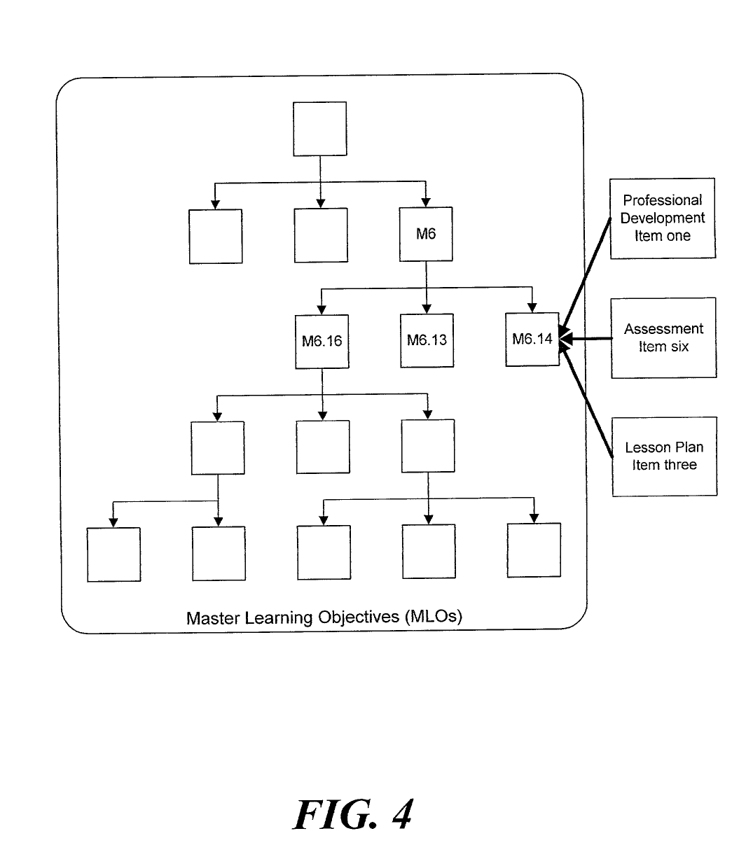

FIG. 4 shows how diverse educational information resources can be correlated with a set of MLOs. In this illustrative example, a certain information element from a professional development data store can be correlated with a Master Learning Objective. Simultaneously, two other data category items can also be correlated against the same MLO.

As shown in FIG. 4, the MLO, M6.14 from the table above, is the learning objective “Understands/uses exponents,” the professional development information object can be a small video (vignette) that discusses how to use a computer system to show the Cartesian mapping of an exponent, the assessment information object is a sub-section that deals with the proper use of exponents and the lesson plan is an information object for 11^{th} grade mid-semester Trigonometry which introduces the concepts of exponents as a precursor to a discussion on logarithms. Note, for example, that assessment information object can be tagged using meta data to indicate that it is an assessment designed for advanced students. This object, while correlated to M6.14 would also allow a user to further differential the information objects to select the appropriate objects that suit their needs.

Individually, each data source can be added to the system. As part of an information data loading effort, each information resource can be specifically reviewed and mapped or correlated against the MLO M6.14. Thereafter, any user of the system can query the system for related educational information resources related to the underlying learning objective. For example, a teacher may locate and access all professional development information associated with a particular lesson plan; an administrator may pull up all lesson plans associated with an important district assessment; a teacher may search and find substitute questions and activities within a lesson plan.

In the event that it is desirable to add information resources, such as student resources for particular subject areas in mathematics including for example transparencies, logarithm tables and vignettes, each of these information objects can be analyzed for content and other meta data categories and correlated to the MLOs quickly and efficiently. The transparencies, logarithm table and vignettes can be determined to relate to the subject of exponents and can be correlated to MLO number M6.14. Thereafter, a teacher (or a student) can locate and access the new resources from the system.

The level of indirection that the MLO's offer permits the system to employ a technique or function known as information hiding. This technique permits the system to be flexible to the changing needs of users and to those who maintain the system. Information hiding includes filtering information as it is delivered to a user based upon user characteristics stored, for example in a user profile.

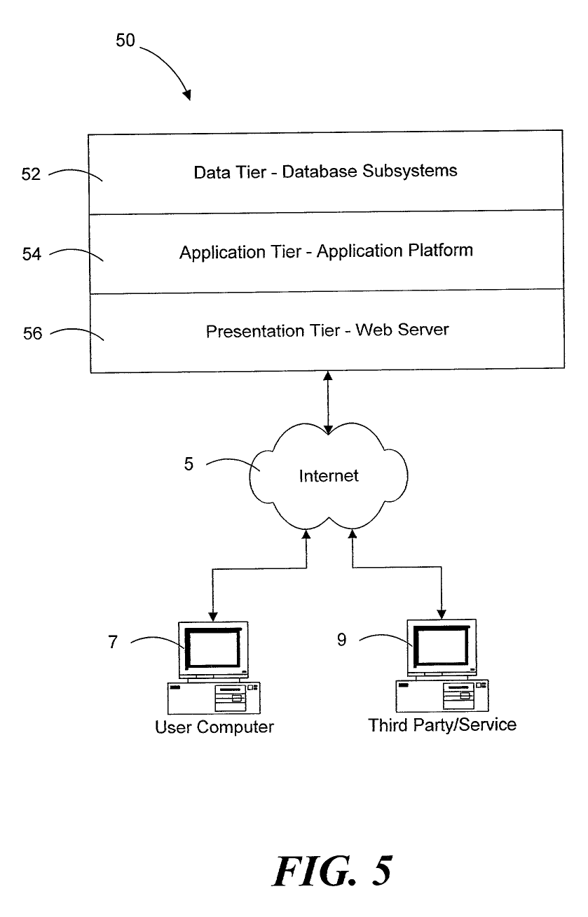

FIG. 5 shows a system 50 embodying the present invention. In this embodiment, the system 50 can be adapted for providing users, such as administrators, teachers, students and parents access to educational information resources over a global communication network such as the internet. The system 50 is more specifically described in commonly owned and assigned, co-pending U.S. Ser. No. [______—Attorney Docket Number 02905.506], filed on [Apr. 19, 2002], entitled Dynamic Content Delivery System and which is hereby incorporated by reference herein, in its entirety. The present invention can be embodied in any system adapted for storing and providing access to information resources.

As shown in FIG. 5, the system 50 includes a data subsystem or tier 52 adapted for storing and providing system access to the plurality of educational information resources, an application server or tier 54 adapted to provide a platform for application programs and functions that enable the user to access the information resources in a usable way and a presentation subsystem which can include web server 56 adapted to provide an interface between the user computer 7 and the application server 54 over a network 5, such as the Internet. The data tier 52 can include one or more computers which can include a plurality of different information storage technologies including a relational database, a file system and a native XML database or data repository. The application tier 54 can include one or more computers and can include one or more application server platforms to support the applications, functions and processes that can permit the installation and maintenance of a set of master learning objectives and other information resources to the system, the correlation of information resources to MLOs and allowing users to search for, locate and retrieve and use various information elements provided by the system 50 as well as other user and administrative functions. The presentation tier 56 can include one or more computers and a web server that can provide an interface to enable a broad range of devices to communicate with and use the system 50.

The system 50 can also be used to create customized information objects and elements by allowing a user to modify an existing information object or element, add a new information object or element to the system 50 and allow the user to combine existing system information objects and elements with modified information objects and elements and new information objects and elements added by a user. Typically, all information objects and elements available from the system can be presented to a user at the user's computer 7 or printed on a user's printer (not shown) or a system printer (not shown). In addition, the system 50 can also be adapted to send information objects and elements to third parties 9 that can provide support services to a user. The third party services can be printing services, such as a KINKO's for printing and binding of a workbook or an activity. The third party services can also be suppliers of materials or other services available to a user and for example, a lesson plan that requires shapes or paint or shop supplies (wood, screws or glue) could be used to generate an order to have these materials delivered to the teacher or generate a request to borrow an instructional video tape or other visual aid. The system 50 can be adapted to interface with third party systems to facilitate access to the third party services. In this regard, the system 50 interface can be as simple as sending an email message to a third party, such as with an attached file to be printed and bound or be highly integrated with a third party ordering system to electronically generate a product or service order.

System 50 can include one or more SUN Microsystems, Sparc computer systems and include the SUN Solaris operating system, both available from Sun Microsystems, Inc. of Palo Alto, Calif. The application platform 54 can include the Java 2 Enterprise Edition platform Enterprise Java Beans, also available from Sun Microsystems. The web server 56 can include Java 2 Enterprise Edition platform and Java Servlet engine providing Java Server Pages, also available from Sun Microsystems. The data subsystem or tier 52 can include a plurality of databases including a relational database such as Oracle (available from Oracle Corp, Redwood Shores, Calif.), a native XML database such as Tamino (available from Software AG, Darmstadt, Germany), Lightweight Directory Access Protocol (LDAP) compatible database and a file system such as the Sun Solaris file system. The above system could also be run on a Hewlett Packard—HP-UNIX system or an IBM Linux system. Alternatively, the system 50 can include one or more IBM (Armonk, N.Y.) compatible computer systems based upon the Intel Corp (Santa Clara, Calif.) family of microprocessors and including the Microsoft Windows Operating system from Microsoft Corp, Redmond, Wash. The application platform can include Microsoft Internet Information Server and Microsoft Transaction Server. The web server can include Microsoft Internet Information Server and use Active Server Pages. The data subsystem can include a plurality of databases including a relational database such as Oracle, Microsoft SQL server or IBM DB2, a native XML database such as Tamino (available from Software AG, Darmstadt, Germany), an LDAP compatible database and a file system such as a SUN Solaris file system or a Microsoft Windows NT File System.

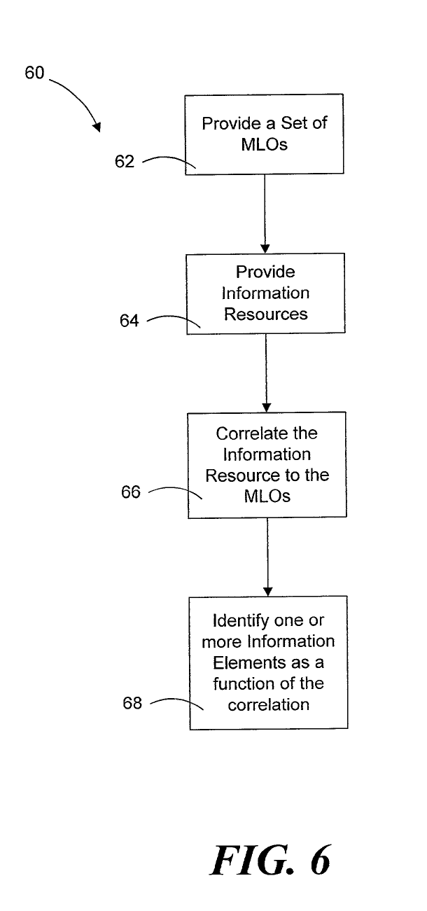

FIG. 6 shows a process 60 according to the present invention. The process 60 includes the steps of providing a set of master learning objectives 62 and a plurality of information resources 64, correlating the information resources to the MLOs at step 66 and identifying one or more information resources as a function of the correlation defined between the individual learning objectives and the information objects and elements of the educational information resources. The correlation step can 66 be performed either manually or automatically or semi-automatically. In addition, system utilities can be provided to facilitate the correlation, validation, re-correlation, and preview processes.

In a manual process, the user or administrator can review each information object or element of a information resource and compare it with the appropriate MLOs and then manually link or correlate each object or element to each appropriate MLO. The manual process can be facilitated using software tools. The process can be semi-automated whereby the user reviews each new information object or element, identifies one or more key words or phrases and uses a search tool to identify the MLO or set of MLOs most likely to correspond to the information object or element. Alternatively, an automatic system can be provided which parses the information objects and elements for words and phrases likely to be descriptive of the information object or element, searches the MLOs based upon the words and phrases found and establishes a correlation between each information object or element and one or more MLOs as a function words or phrases found. Before each correlation is accepted into the system, a user can manually review the correlation for accuracy. One of the benefits of the present system is that even with the manual process, the correlation step need only be performed once when the new information is added as compared with the free form information model where each new information object or element would have to be correlated with each existing information resource of the system.

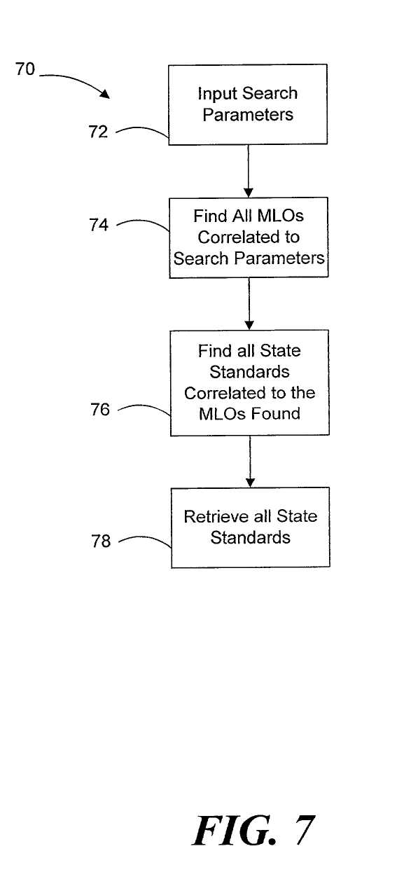

FIGS. 7 through 9 show some of the methods of finding correlated resources in accordance with the present invention. The information resources can exist in many different forms and can be stored in various manners (a database, a flat file, an XML database or an LDAP database), however all share one thing in common—they all can be referenced with meta-data that will correlate them to a central database of learning standards or MLOs.

Preferably, the MLOs are a comprehensive and granular list of individual learning objectives that include common meta-data elements for correlating all information resources. Using the MLOs, different information resources can be correlated against each other.

For example, a lesson plan on lasers and holograms can be correlated to a MLO called “Science.Physics.Optics.Lasers.” At the same time, a book on lasers by Dr. Spock can also be correlated against Science.Physics.Optics.Lasers” and a professional development item can also be correlated against ‘Science.Physics.Optics.Lasers.” The educational information resources (or assets) are not directly linked to the lesson plan, but because of these correlations, a teacher finding the lesson plan will be able to immediately find what resources will help her teach this subject, from professional development resources, to textbooks, to student resources. The MLOs can set at the center of all correlations between resources (and assets).

Preferably the MLOs are assembled into hierarchies. At the top of an MLO hierarchy is a general subject area. Each level down in the hierarchy can narrow down the topic/subject. For example, Physics can be a child node under Science, and Optics can be a child node under Physics, forming a tree that narrows the scope of the learning objective as we traverse down the tree and organizing the learning objectives into hierarchical topologies. Preferably, at the bottom of the tree are the most granular and atomic of learning objectives and usually take on the form of a description of what a student should know: “Student knows the difference between constructive and destructive interference in holographic imaging.”

An MLO can be ANY node on the tree. This includes topic nodes all the way down, so that science is an MLO, as is Science.Physics as is Science.Physics.Optics.Lasers.Holograms. Information resources are generally correlated as close to the end or leaf-node MLOs as possible. For instance, the lesson plan on lasers and holograms can be correlated to the MLO: Science.Physics.Optics.Lasers.Holograms. Student knows the difference between constructive and destructive interference in holographic imaging However, an information object or element of any information resource can be correlated to any node including non-leaf nodes.

FIG. 7 shows a flowchart of a simple process 70 for performing a correlation query. A correlation query is a process to find those information objects and elements that are correlated against a particular information object or element. For example, finding State Standards that are correlated to lesson Plan. The process includes the steps of entering the search parameters that form the basis of the search at 72. The parameters can include an identification of the lesson plan and the indication that the results should be from information resources containing state standards. In step 74, the system finds all MLOs correlated against the input information object (in our example, the lesson plan). In step 76, the system finds all information object or element correlated against all MLOs found in step 74 which are State Standards and in step 78 the system retrieves the information objects or elements, the State Standards we were searching for.

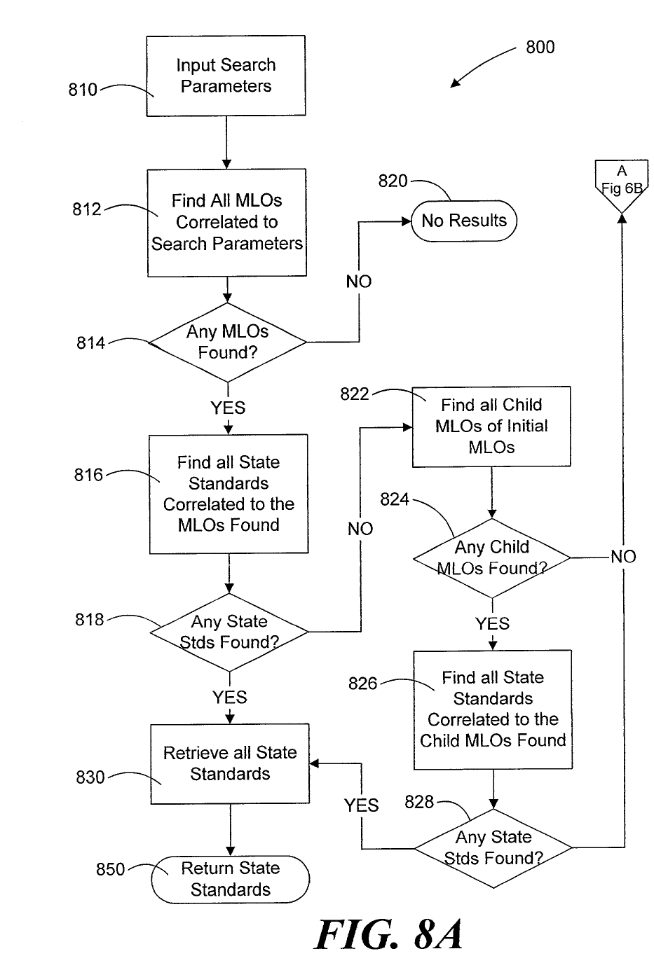

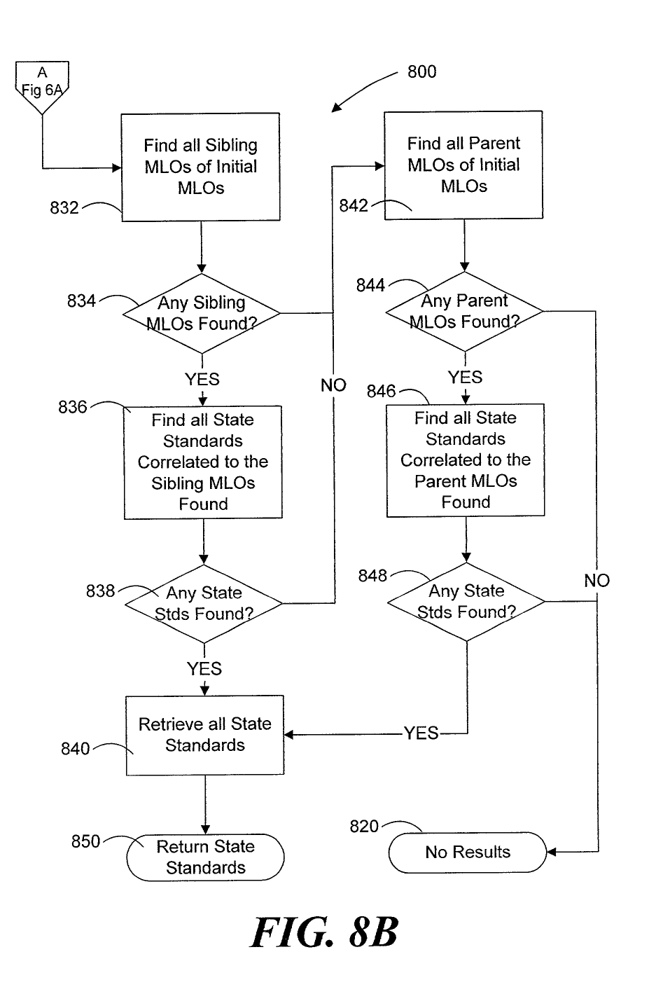

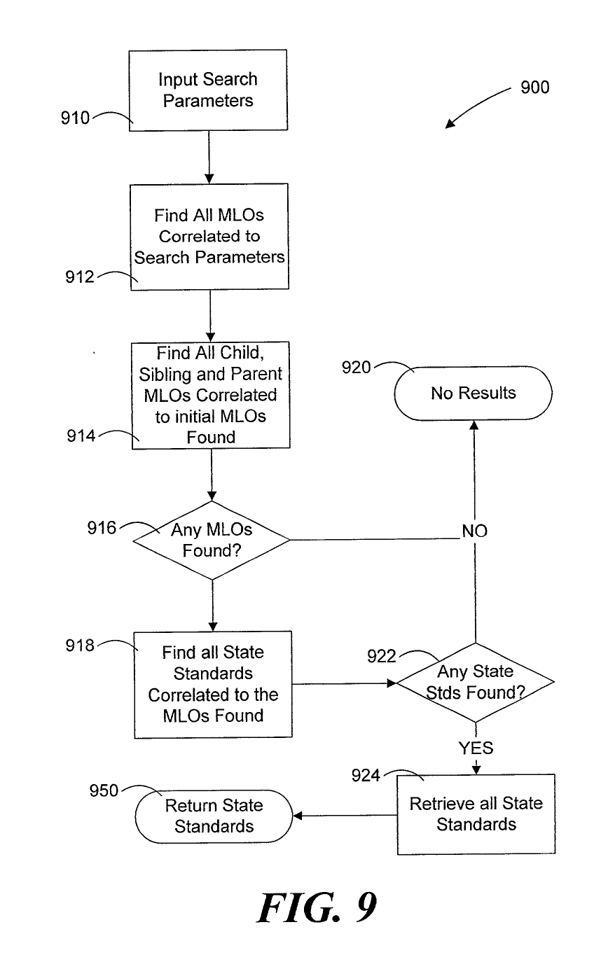

The process of FIG. 7 can become problematic when no correlations are defined for the search parameters or no state standards are correlated to the MLOs found in step 74. FIGS. 8A and 8B and 9 provide alternative processes which address the problem where no correlations are defined for the search parameters. The process of FIGS. 8A and 8B test to determine whether a result was obtained at each search step and where no results are found the process explores related (parent child and sibling) MLOs. The process of FIG. 9 searches for all possible MLOs initially.

FIGS. 8A and 8B show a flowchart of an alternative process 800 for performing a correlation query to identify the state standards correlated to a lesson plan. At step 810, the process includes entering the search parameters that form the basis of the search. The parameters can include an identification of the lesson plan and the indication that the results should be from information resources containing state standards. At step 812, the system searches for all MLOs correlated to the search parameters and at step 814, the system tests to determine in any MLOs were found. If no MLOs were found at step 812, the process terminates at step 820 because the information resource has not been correlated. If any MLOs were found, the system searches at step 816, for all state standards that are correlated to the MLOs found at 812 and at step 818, the system tests to determine if any state standards were found. If any state standards are found at 816, the state standards are retrieved at step 830 and process is completed at step 850. If no state standards are found at step 816, the system proceeds to step 822 to search for all child MLOs of the initial MLOs found in step 812 and at step 824, the system tests to determine if any child MLOs were found. If any child MLOs were found in step 822, the system proceeds to step 826 to search for state standards correlated to the child MLOs and at step 828, the system tests to determine if any state standards were found. If any state standards are found at 826, the state standards are retrieved at step 830 and process is completed at step 850. If no child MLOs are found at step 822 or no state standards are found at step 828 the process can continue to step 832 where the system can search for all sibling MLOs of the initial MLOs found and at step 834, the system tests to determine if any sibling MLOs were found. If any sibling MLOs were found in step 832, the system proceeds to step 836 to search for state standards correlated to the sibling MLOs and at step 838, the system tests to determine if any state standards corresponding to the sibling MLOs were found. If any state standards are found at 836, the state standards are retrieved at step 840 and process is completed at step 850. If no sibling MLOs are found at step 832 or no state standards are found at step 836 the process can continue to step 842 where the system can search for all parent MLOs of the initial MLOs found and at step 844, the system tests to determine if any parent MLOs were found. If any parent MLOs were found in step 842, the system proceeds to step 846 to search for state standards correlated to the parent MLOs and at step 848, the system tests to determine if any state standards corresponding to the parent MLOs were found. If any state standards are found at 846, the state standards are retrieved at step 840 and process is completed at step 850. If no parent MLOs are found in step 844 or no state standards are found in step 846, process steps at step 820 indicating that the information resource may not have been correlated to the set of MLOs.

FIG. 9 shows a flowchart of an alternative process 900 for performing a correlation query to identify the state standards correlated to a lesson plan. At step 910, the process includes entering the search parameters that form the basis of the search. The parameters can include an identification of the lesson plan and the indication that the results should be from information resources containing state standards. At step 912, the system searches for all MLOs correlated to the search parameters and at step 914, the system searches for all child, sibling and parent MLOs of the MLOs found in step 912. At step 916, the system tests to determine in any MLOs were found. If no MLOs were found at steps 912 and 914, the process terminates at step 920 because the information resource has not been correlated. If any MLOs were found, the system searches at step 918, for all state standards that are correlated to the MLOs found at steps 912 and 914 and at step 922, the system tests to determine if any state standards were found. If any state standards are found at 918, the state standards are retrieved at step 924 and process is completed at step 950.

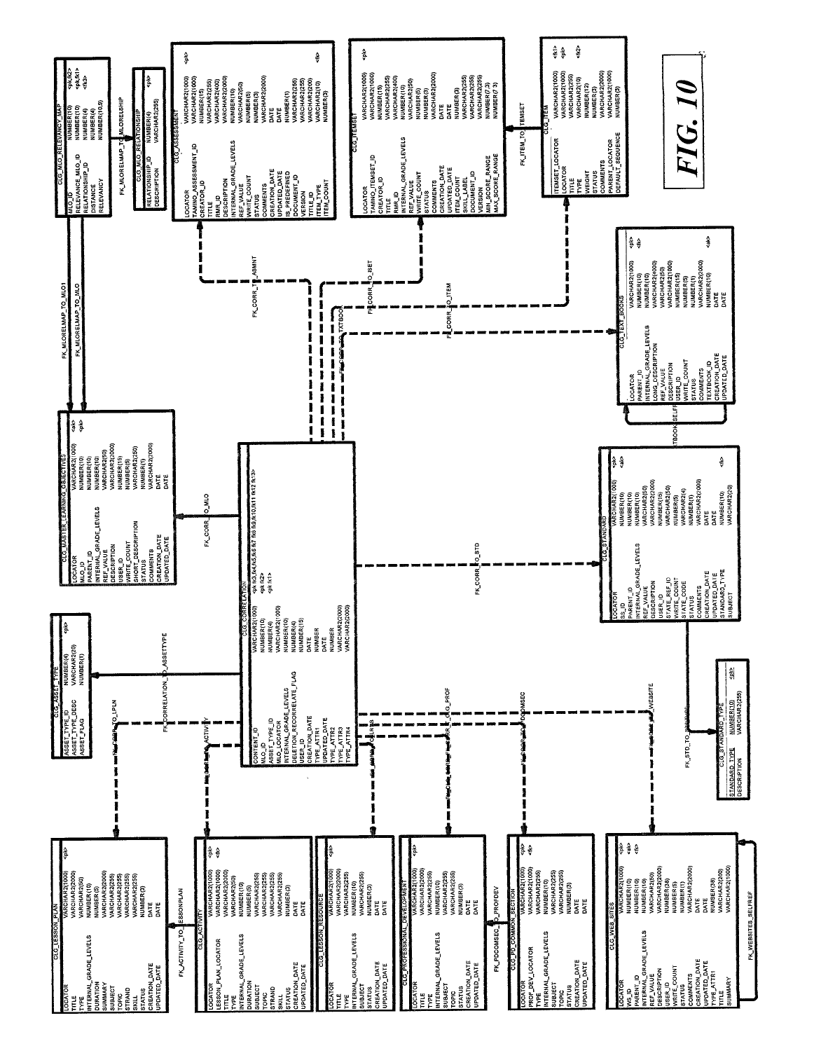

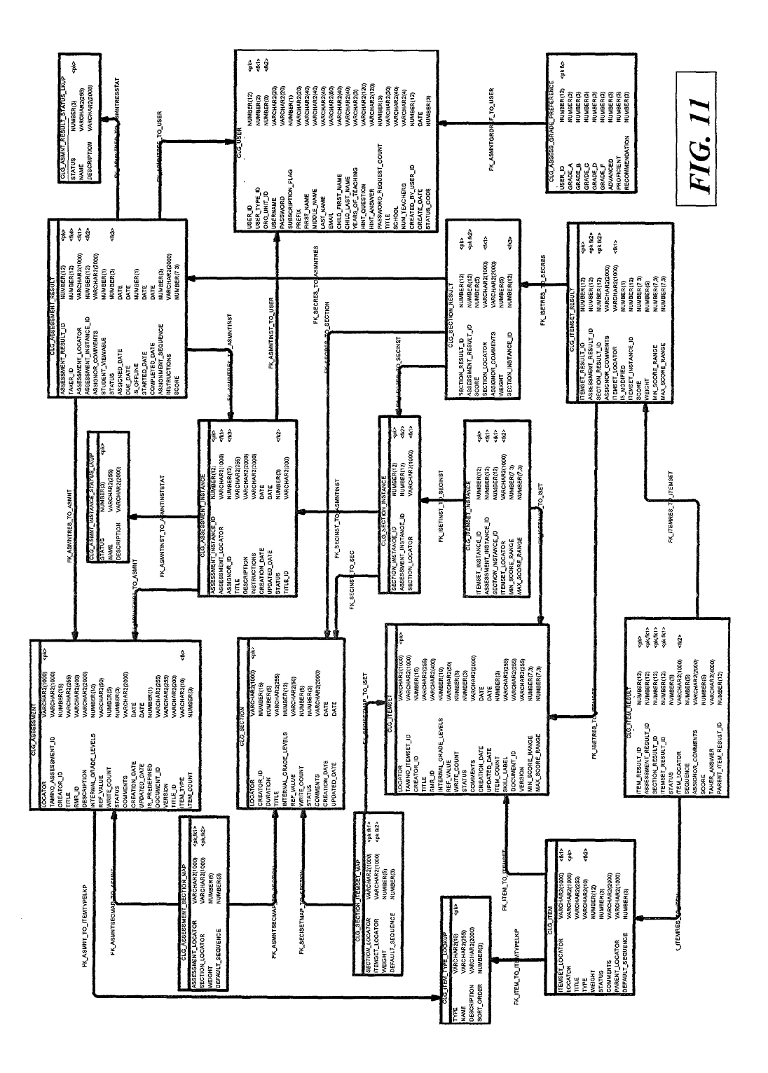

FIGS. 10 and 11 show diagrammatic views of a set of data structures in accordance with one embodiment of the invention. The data structures include meta-data which are used to correlate the information objects and elements of the information resources to the MLOs. The correlation data object can include the following meta-data fields or attributes: a locator or unique value which is the primary key of the data object and identifies an information object, an asset type id which is a value that reflects the type of information resource (state standard, lesson plan, assessment, professional development, textbook, etc) and an MLO ID which identifies the MLO that information object or element is correlated to. The correlation data object can also include a status attribute to indicate that the data object is inactive or not used, a creation data field and an updated field. A shown in FIG. 10, the data structure also includes a separate data object that corresponds each type of information resource. For example, state and district standards type data object can include a the following meta-data fields or attributes: a locator or unique value which is the primary key of the data object and identifies an information object or element in the correlation data object, a standard ID field, a parent ID field, a grade level attribute, a reference field, a description field, a comments field, creation and update date fields. The textbook type data object can include a locator or unique value which is the primary key of the data object and identifies an information object or element, a parent ID field, a grade level field, long and short description fields, a comments field, creation and update date fields. The assessment type data object can include a locator or unique value which is the primary key of the data object and identifies an information object or element, a title field, a grade level field, a description field, a comments field, creation and update date fields. The professional development type data object can include a locator or unique value which is the primary key of the data object and identifies an information object or element, a type field, a grade level field, subject and topic fields and a skill level field. MLO data object can include a locator or unique value which is the primary key of the data object and identifies the MLO, a parent ID field, a grade level field, long and short description fields, a comments field, creation and update date fields. These data structure can form part of a database that stores the data objects and elements and the meta-data and is used in queries to find information objects and elements.

As shown in FIGS. 10 and 11, the system can include a separate database for identifying each type of information resource and new types of resources can be added as necessary. A generic database can be included for information resources that do not fit in with any of the predefined resource types. In addition, additional databases for types of objects and elements of a particular type can also be included. For example, there can be a database for lesson plan resources which catalogs all the lesson plans available within the system and, in addition, there can additional databases that catalog the lesson plan activities and other elements of the lesson plan objects. The system can include a record in the appropriate database for each information object and each information element of a given resource and that record can include meta data identifying attributes of the object or element. For example, a lesson plan record can include a locator field identifying the location of the lesson plan, a title field identifying the title of the lesson plan, a type field identifying the type of resource (i.e. lesson plan type resource), an internal_grade_levels field identifying the grade levels of the lesson plan, a duration field identifying the duration of the lesson plan, a summary field for a summary description of the lesson plan, a status field identifying the status of the lesson plan (active, inactive, retired, etc.), the creation date of the lesson plan and the date it was last updated. In addition, each object and element can include meta data which further characterizes or categorizes the object or element. For example, the lesson plan record can include Subject, Topic, Strand and Skill fields which can correspond to levels within the hierarchy of the MLOs, such as Subject: Science, Topic: Physics, Strand: Optics, Lasers, Holograms, Skill: Student knows the difference between constructive and destructive interference in holographic imaging. This meta data can be derived from available data when the information resource is input into the system or it can be manually entered by a user when the resource is added to the system. The system can also provide tools which facilitate the input of this information. The input process can be automated using key words found in the information object or element and these tools can use these key words to suggest the subject, topic, strand and skill or similar attributes.

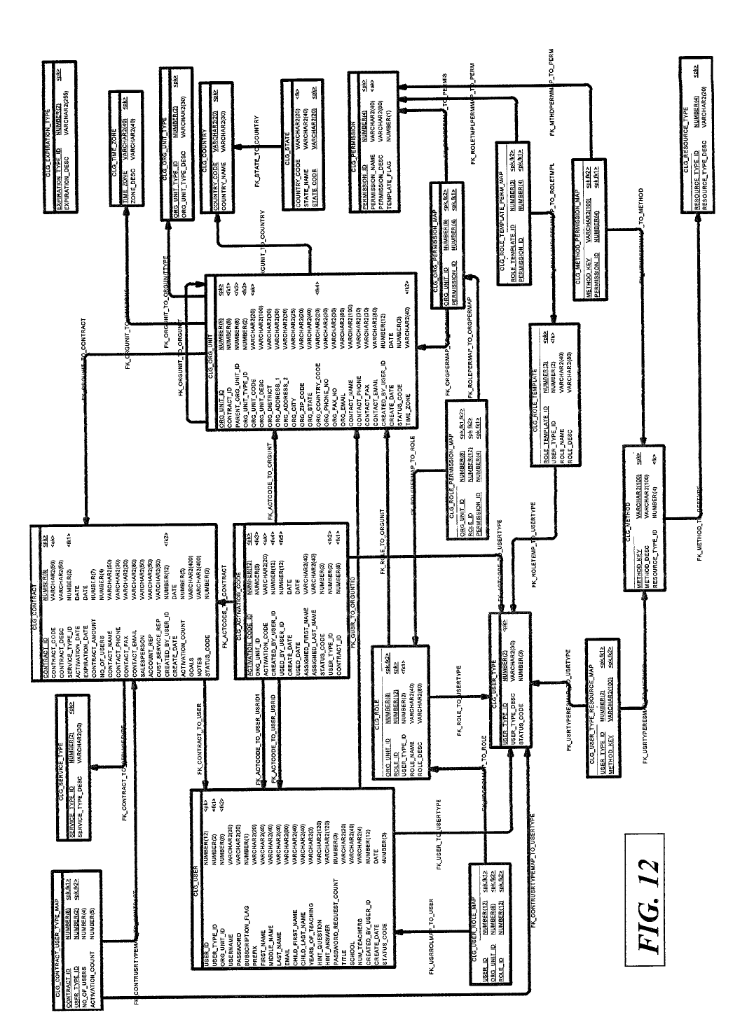

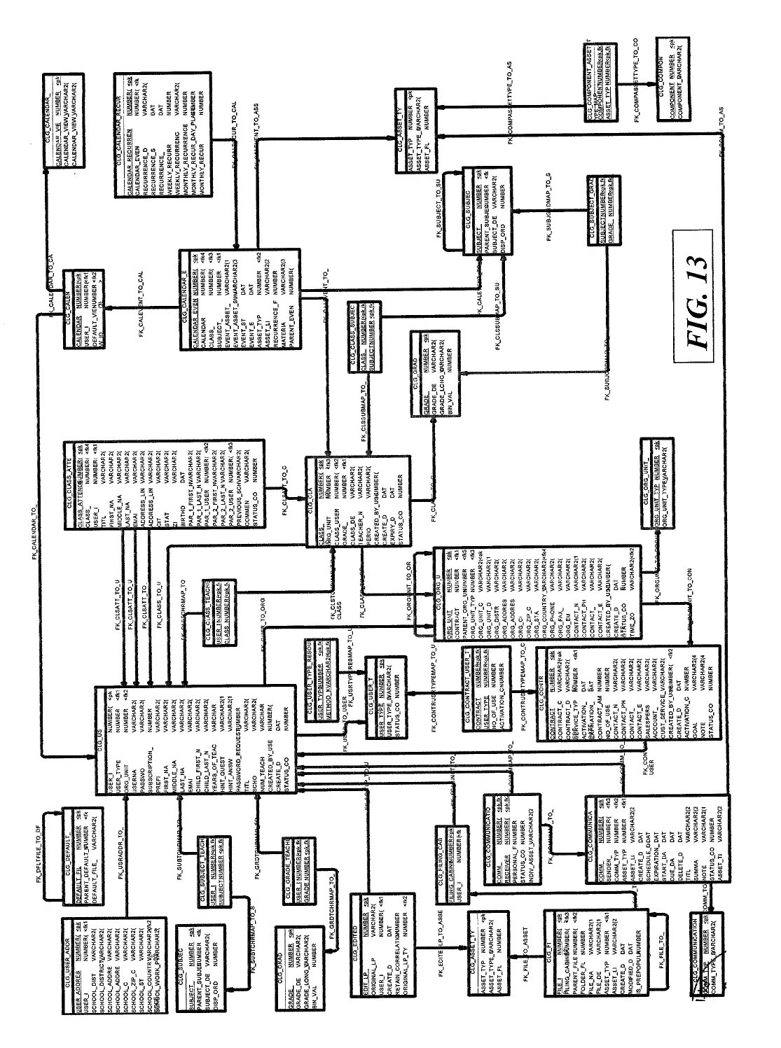

FIGS. 12 and 13 show a diagrammatic view of a set of data structures for storing user information in accordance with an embodiment of the present invention. The user information includes the type of user (administrator, teacher, student or parent) and other information about the user's activities that are maintained by the system. This can include the user's schedule or calendar, the user's grade and class as well as correspondence with other users files that are stored for the benefit of the user.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A system for storing a plurality of educational information resources comprising:
a plurality of separate educational information resources, each information resource including a plurality of information objects;
a set of master learning objectives, each objective including a category of learning objectives;
means for correlating at least one of the information objects with at least one of said master learning objectives.

2. A system according to claim 1 wherein said plurality of separate educational information resources includes at least one information resource containing educational standards information.

3. A system according to claim 2 wherein said educational standards information includes state standards.

4. A system according to claim 2 wherein said educational standards information includes district standards.

5. A system according to claim 1 wherein said plurality of separate educational information resources includes state standards information and district standards information.

6. A system according to claim 1 wherein said plurality of separate educational information resources includes at least one information resource selected from a group comprising state standards resources, district standards resource, professional development resources, assessment resources, lesson plan resources, student resources, and textbook resources.

7. A system according to claim 1 wherein said set of master learning objectives includes a plurality of hierarchically organized learning objectives.

8. A system according to claim 7 wherein the hierarchically organized learning objectives are organized to include a plurality of hierarchical levels in which higher levels include more general categories of learning objectives and lower levels include more specific categories of learning objectives.

9. A system according to claim 1 further comprising an information delivery system, said information delivery system being adapted for delivering an information object to a user as a function of a correlation defined between a master learning objective and said information object.

10 A system according to claim 1 wherein said correlation means includes a set of data representative of a correlation between a master learning objective and at least one information object from said plurality of educational information resources.

11. A system according to claim 1 wherein said correlation means includes a database defining a correlation between a master learning objective and at least one information object from said plurality of educational information resources.
